(19) United States
(12) Patent Application Publication
(10) Pub. No.: US 2019/0213271 A1
(43) Pub. Date: Jul. 11, 2019

(54) METHOD AND SYSTEM FOR DATA EXCHANGE CRITICAL EVENT NOTIFICATION

(71) Applicants: Vijay Saradhi Musku, Bangalore (IN); Hanamanth Pujari, Bangalore (IN)

(72) Inventors: Vijay Saradhi Musku, Bangalore (IN); Hanamanth Pujari, Bangalore (IN)

(73) Assignee: Unisys Corporation, Blue Bell, PA (US)

(21) Appl. No.: 15/884,789

(22) Filed: Jan. 31, 2018

(30) Foreign Application Priority Data
Jan. 9, 2018 (IN) 201811000906

(51) Int. Cl. G06F 17/30

(52) U.S. Cl. CPC G06F 17/30368; G06F 17/30569; G06F 17/303

(57) ABSTRACT

A method and system for notifying a database administrator of a database deadlock, error or other critical event during a database data exchange data transformation process. The method includes receiving and saving data exchange subscription information associated with a data exchange operation between a source database and a target database, and receiving and saving notification information associated with at least one computing device of a database administrator. The method also includes capturing a critical event as the critical event occurs during the database data exchange data transformation process. The method also includes providing notification of the captured critical event, and sending a critical event notification.

### BACKGROUND

### Field

The instant disclosure relates to database data exchange transformations, and in particular to methods and systems for data exchange critical event notification during a database data exchange transformation.

### Description of the Related Art

Database data exchange operations include the transformation of data from a source database to a target database. For example, data from a source database, such as a Unisys DMSII (Data Management System II) database or a Unisys RDMS (Relational Data Server) database, can be transformed, as part of a database data exchange operation, for use in a target database, such as an SQL (structure query language) database or an ORACLE database. Database data exchange operations can support many different data transformation combinations between these kinds of databases and other databases.

Some database data exchange operations require little if any time to transform data from a source database to a target database. Also, some database data exchange operations allow a database user to modify all or a portion of the data being transformed from the source database to the target database.

Many database data exchange operations can operate continuously on a defined data transformation from a source database to a target database. During this data transformation process, one or more errors or other critical events may occur, e.g., due to the complexity of the design of the source database and/or the target database, or for some other reason. During the generation of an error or other critical event, the source database and/or the target database may enter into deadlocked state, causing the data transformation operation to fail or to cease operating properly.

In the event that a source database and/or a target database becomes deadlocked or hung during a data exchange data transformation process, the database administrator (DBA) may want to perform a recovery or reorganization process on the deadlocked database(s). Typically, it is relatively difficult for a database administrator to know immediately when a data transformation error has occurred, unless the database administrator is continuously monitoring the database(s) during the data exchange data transformation process, or happens to be monitoring the database(s) when the data transformation error occurs. For cases in which a database becomes deadlocked during a data transformation process, or for cases in which a particularly critical error has occurred during the data transformation process, immediate attention from the database administrator often is required. Otherwise, a database administrator will not know about the deadlock or the critical error(s) until and unless the database administrator accesses one or more of the database runtime service log and the database data exchange event page associated with the database, or unless the database administrator directly accesses the database data exchange operation.

There is a need for immediate notification to a database administrator of a database deadlock, error or other critical event during a database data exchange data transformation process, e.g., a short message service (SMS) notification and/or an email notification.

### SUMMARY

Disclosed is a method and system for notifying a database administrator of a database deadlock, error or other critical event during a database data exchange data transformation process. The method includes receiving and saving data exchange subscription information associated with a data exchange operation between a source database and a target database, and receiving and saving notification information associated with at least one computing device of a database administrator. The method also includes capturing a critical event as the critical event occurs during the database data exchange data transformation process. The method also includes providing notification of the captured critical event, and sending a critical event notification.

### BRIEF DESCRIPTION OF THE DRAWINGS

FIG. 1 is a schematic view of a system for providing notification of a database deadlock, error or other critical event during a database data exchange data transformation process, according to an embodiment; and

FIG. 2 is a flow diagram of a method for generating a notification of a database deadlock, error or other critical event during a database data exchange data transformation process, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting, and merely set forth some of the many possible embodiments for the claimed invention.

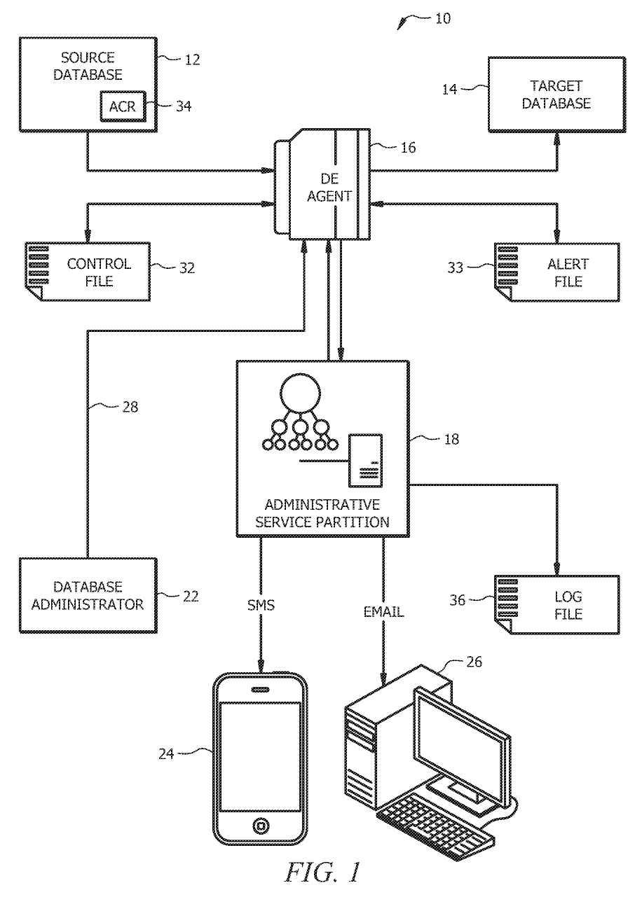

FIG. 1 is a schematic view of a system 10 for providing notification to a database administrator of a database deadlock, error or other critical event during a database data exchange data transformation process, according to an embodiment. As discussed hereinabove, data exchange operations include the exchange or transformation of data from a source database 12 to a target database 14. The data exchange or transformation typically involves the use of a data exchange agent 16 coupled directly or indirectly between the source database 12 and the target database 14.

One or more of the source database 12, the target database 14 and the data exchange agent 16 can be a standalone component or machine, or can be a component within a larger standalone component or machine. Also, it should be understood that more than one of the source database 12, the target database 14 and the data exchange agent 16 can be part of the same standalone component or machine. Regardless of the particular configuration of the source database 12, the target database 14 and the data exchange agent 16, it should be understood that the relationship between the source database 12 and the target database 14 is a machine-to-machine connection, and involves machine-to-machine communications, i.e., the exchange of data between machines. For example, the source database 12 and the target database 14 can be separate host components, and the data exchange agent 16 can be a third host component, or part of a third host component, coupled between the source database 12 and the target database 14 host components.

The data exchange agent 16 can include or have coupled thereto a controller or controlling agent, such as an administrative service agent 18. Although the administrative service agent 18 is shown as a standalone component coupled to the data exchange agent 16, it should be understood that the administrative service agent 18 can be an internal component within the data exchange agent 16.

Typically, as part of a conventional data exchange operation, the data exchange agent 16 receives database data from the source database 12, and exchanges or transforms the database data received from the source database 12 into database data that is suitable for use by the target database 14. Upon transforming the database data received from the source database 12, the data exchange agent 16 sends the transformed database data to the target database 14. For example, the source database 12 can be a Unisys DMSII (Data Management System II) database, the target database 14 can be an SQL database, and the data exchange agent 16 can be a data exchange component that is configured to transform Unisys DMSII database data to database data that is suitable for use in the SQL database.

As discussed hereinabove, during a data transformation process, one or more errors or other critical events may occur, often causing the source database 12 and/or the target database 14 to enter into deadlocked state, causing the data transformation operation to fail or cease operating properly. In the event of such an error or other critical event, the source database 12 and/or the target database 14 typically require immediate attention to correct the error and to restore the proper operation of the data transformation process. However, in conventional data transformation operations, a database administrator does not know of such a critical event unless the database administrator is monitoring the data transformation process continuously, or happens to be monitoring the data transformation process at the exact moment that the critical event occurs. Typically, in conventional data transformation operations, a database administrator finds out about such a critical event only when the database administrator logs into the data exchange system and reviews the data exchange operational logs.

According to an embodiment, the data exchange system 10 provides immediate notification to a database administrator (DBA) 22 of a critical error or other critical event, e.g., in the form of an SMS notification to a mobile computing device 24 of the database administrator 22 and/or an email notification to a computing device 26 of the database administrator 22. The immediate notification of the critical event allows the database administrator 22 to begin resolving the problem(s) associated with the critical event at the time the critical event occurs, e.g., by initiating a suitable recovery or reorganization process.

According to an embodiment, to receive immediate notification of a critical error or other critical event during a data exchange operation, the database administrator 22 subscribes or otherwise petitions for a specific data exchange operation to occur between the source database 12 and the target database 14. The subscription by the database administrator 22 for a specific data exchange operation between the source database 12 and the target database 14 is shown generally as a connection or communication 28 between the database administrator 22 and the data exchange agent 16. Upon receiving the data exchange operation subscription information, the data exchange agent 16 saves the data exchange operation subscription information in the administrative service agent 18 coupled to the data exchange agent 16. The data exchange agent 16 also saves the data exchange operation subscription information in a database specific control file 32.

When the database administrator 22 subscribes for a specific data exchange operation between the source database 12 and the target database 14, the data exchange agent 16 provides an interface or other suitable mechanism for accepting notification information from the database administrator 22, e.g., the SMS number of the portable computing device 24 of the database administrator 22 and/or the email address of the computing device 26 of the database administrator 22. The database administrator 22 provides the notification information to the data exchange agent 16, and the data exchange agent 16 stores the notification information of the database administrator 22 in an alert file 33.

Once the data exchange agent 16 has received the data exchange operation subscription information (and the notification information), and the notification information has been saved in the alert file 33, an access routine (ACR) library component 34, which is created when the source database 12 is created, is triggered to begin capturing any errors or other critical events occurring as part of a data exchange operation being performed between the source database 12 and the target database 14. The ACR library 34 is a component that typically resides within the source database 12, and is created when the source database 12 is created, e.g., using a database description file.

The ACR library 34 captures critical events as they occur and notifies the data exchange agent 16 of any captured critical events. The ACR library 34 also provides information associated with the captured critical events to the data exchange agent 16. The data exchange agent 16 writes the critical event information into a log file 36 via the administrative service agent 18. That is, data exchange agent 16 provides the critical event information to the administrative service agent 18, and the administrative service agent 18 writes the critical event information to the log file 36.

When a critical event has been captured and the critical event information has been written to the log file 36, the data exchange agent 16 reads the alert file 33 to determine where to send a notification of the captured critical event. The data exchange agent 16 provides this information to the administrative service agent 18.

As discussed hereinabove, the alert file 33 has stored therein the notification information from the database administrator 22, e.g., the SMS number of the portable computing device 24 of the database administrator 22 and/or the email address of the computing device 26 of the database administrator 22. The administrative service agent 18 then generates a critical event alert notification and sends the generated critical event alert notification to the database administrator 22 based on the notification information of the database administrator 22 stored in the alert file 33. According to an embodiment, the administrative service agent 18 can generate a critical event alert notification and send the generated critical event alert notification to the database administrator 22 before or after the ACR library 34 writes the captured critical event into the log file 36.

According to an embodiment, the database administrator 22 is notified immediately of any critical event that occurs during a data exchange operation performed by the data exchange agent 16, e.g., via an SMS notification to the mobile computing device 24 of the database administrator 22 and/or an email notification to the computing device 26 of the database administrator 22. Accordingly, the database administrator 22 can immediately attend to the critical event, e.g., the database administrator 22 can initiate a suitable recovery or reorganization process to immediately begin resolving the problem(s) associated with the critical event.

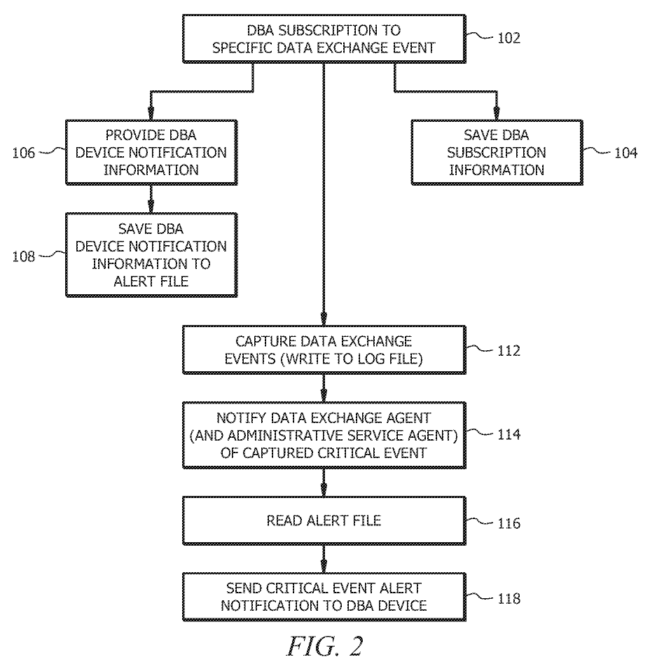

FIG. 2 is a flow diagram of a method 100 for generating a notification of a database deadlock, error or other critical event during a database data exchange data transformation process, according to an embodiment. The method 100 includes a step 102 of the database administrator (DBA) 22 subscribing or otherwise petitioning the data exchange agent 16 for a specific data exchange operation to occur between the source database 12 and the target database 14.

The method 100 also includes a step 104 of the data exchange agent 16 saving the data exchange operation subscription information in the administrative service agent 18 coupled to the data exchange agent 16. Upon receiving the data exchange operation subscription information, the data exchange agent 16 saves the data exchange operation subscription information in the administrative service agent 18. As discussed hereinabove, the administrative service agent 18 saves the data exchange operation subscription information in the database specific control file 32.

The method 100 also includes a step 106 of the database administrator 22 providing notification information to the data exchange agent 16. As discussed hereinabove, when the database administrator 22 subscribes for a specific data exchange operation between the source database 12 and the target database 14, the data exchange agent 16 provides an interface or other suitable mechanism for accepting notification information from the database administrator 22, e.g., the SMS number of the portable computing device 24 of the database administrator 22 and/or the email address of the computing device 26 of the database administrator 22.

The method 100 also includes a step 108 of saving the notification information to the alert file 33. Once the database administrator 22 provides the notification information to the data exchange agent 16, the data exchange agent 16 stores the notification information of the database administrator 22 in an alert file 33, via the administrative service agent 18.

The method 100 also includes a step 112 of the access routine (ACR) library component 34 capturing any errors or other critical events occurring in the data exchange agent 16 as part of a data exchange operation being performed between the source database 12 and the target database 14. As discussed hereinabove, once the administrative service agent 18 has received the data exchange operation subscription information (and the notification information), and the notification information has been saved in the alert file 33, the access routine (ACR) library component 34 is triggered to begin capturing any errors or other critical events occurring in the data exchange agent 16 as part of a data exchange operation being performed between the source database 12 and the target database 14. The ACR library 34 writes any captured critical events into the log file 36.

The method 100 also includes a step 114 of the ACR library 34 notifying the data exchange agent 16 of any captured critical events. When the ACR library 34 captures any errors or other critical events occurring in the data exchange agent 16 as part of a data exchange operation being performed between the source database 12 and the target database 14, the ACR library 34 notifies the data exchange agent 16 of any such captured critical events.

The method 100 also includes a step 116 of the administrative service agent 18 reading the alert file 33 to determine where to send a notification of a captured critical event.

The method 100 also includes a step 118 of the administrative service agent 18 sending a critical event alert notification to the database administrator 22, based on the notification information of the database administrator 22 stored in the alert file 33. As discussed hereinabove, the alert file 33 has stored therein the notification information from the database administrator 22, e.g., the SMS number of the portable computing device 24 of the database administrator 22 and/or the email address of the computing device 26 of the database administrator 22. The administrative service agent 18 generates a critical event alert notification and sends the generated critical event alert notification to the database administrator 22, based on the notification information of the database administrator 22 stored in the alert file 33, e.g., via an SMS notification to the mobile computing device 24 of the database administrator 22 and/or an email notification to the computing device 26 of the database administrator 22.

It will be apparent to those skilled in the art that many changes and substitutions can be made to the embodiments described herein without departing from the spirit and scope of the disclosure as defined by the appended claims and their full scope of equivalents.

1. A method for providing notification of a critical event during a database data exchange data transformation process between a source database and a target database, the method comprising:
receiving by a data exchange agent coupled between the source database and the target database data exchange subscription information associated with a data exchange operation between the source database and the target database;
saving the data exchange subscription information to a database specific control file coupled to the data exchange agent;
receiving by the data exchange agent notification information associated with at least one computing device of a database administrator;
saving the notification information to an alert file coupled to the data exchange agent;
in response to receiving the data exchange subscription information, capturing a critical event as the critical event occurs during the database data exchange data transformation process;
notifying the data exchange agent of the captured critical event;
reading the alert file to determine where to send a notification of the captured critical event; and
sending a critical event alert notification based on the notification information in the alert file.

2. The method as recited in claim 1, wherein capturing a critical event as the critical event occurs during the database data exchange data transformation process further comprises an ACR library coupled to the source database capturing the critical event.

3. The method as recited in claim 2, wherein the ACR library provides information associated with a captured critical event to the data exchange agent, and wherein the data exchange agent writes the information associated with the captured critical event in a log file coupled to the data exchange agent.

4. The method as recited in claim 1, wherein reading the alert file to determine where to send a notification of the captured critical event further comprises an administrative service agent coupled to the data exchange agent reading the saved notification information in the alert file to determine where to send a notification of a captured critical event.

5. The method as recited in claim 1, wherein sending the critical event alert notification based on the notification information further comprises an administrative service agent coupled to the data exchange agent sending the critical event alert notification to a computing device of a database administrator associated with the data exchange subscription information.

6. The method as recited in claim 1, wherein the notification information associated with at least one computing device of a database administrator is at least one of an SMS number of a portable computing device of the database administrator and an email address of a computing device of the database administrator.

7. The method as recited in claim 1, wherein the source database is Unisys DMSII (Data Management System II) database, and wherein the target database is an SQL (structured query language) database.

8. A system for providing notification of a critical event during a database data exchange data transformation process between a source database and a target database, the system comprising:
a data exchange agent coupled between the source database and the target database;
an access routine (ACR) library component coupled to the source database; and
an administrative service agent coupled to the data exchange agent,
wherein the data exchange agent receives data exchange subscription information associated with a data exchange operation between the source database and the target database,
wherein the data exchange agent saves the data exchange subscription information to a database specific control file coupled to the data exchange agent,
wherein the data exchange agent receives notification information associated with at least one computing device of a database administrator,
wherein the data exchange agent saves the notification information to an alert file coupled to the data exchange agent,
wherein, in response to the data exchange subscription information being received, the ACR library component captures a critical event as the critical event occurs during the database data exchange data transformation process,
wherein the ACR library component notifies the data exchange agent of the captured critical event;
wherein the data exchange agent notifies the administrative service agent of the captured critical event;
wherein the administrative service agent writes the critical event in a log file coupled to the administrative service agent;
wherein the data exchange agent reads the alert file to determine where to send a notification of the captured critical event,
wherein the data exchange agent instructs the administrative service agent where to send the notification of the captured critical event, and
wherein the administrative service agent sends a critical event notification based on the notification information in the alert file.

9. The system as recited in claim 8, wherein the administrative service agent sends the critical event alert notification to a computing device of a database administrator associated with the data exchange subscription information.

10. The system as recited in claim 8, wherein the notification information associated with at least one computing device of a database administrator is at least one of an SMS number of a portable computing device of the database administrator and an email address of a computing device of the database administrator.

11. The system as recited in claim 8, wherein the source database is Unisys DMSII (Data Management System II) database, and wherein the target database is an SQL (structured query language) database.
